(19) United States
(12) Patent Application Publication
(10) Pub. No.: US 2013/0303070 A1
(43) Pub. Date: Nov. 14, 2013

(54) INTAKE DEVICE FOR FUEL CELL VEHICLE

(71) Applicants: Naoki Ozawa, Shizuoka-ken (JP); Shiro Matsumoto, Shizuoka-ken (JP); Kengo Ikeya, Shizuoka-ken (JP); Damian Patrick Davies, Nottinghamshire (GB)

(72) Inventors: Naoki Ozawa, Shizuoka-ken (JP); Shiro Matsumoto, Shizuoka-ken (JP); Kengo Ikeya, Shizuoka-ken (JP); Damian Patrick Davies, Nottinghamshire (GB)

(73) Assignee: SUZUKI MOTOR CORPORATION, Shizuoka-ken (JP)

(21) Appl. No.: 13/979,310

(22) PCT Filed: Feb. 29, 2012
(86) PCT No.: PCT/JP2012/055018

§ 371 Date: Jul. 11, 2013

(30) Foreign Application Priority Data
Mar. 4, 2011 (JP) 2011-047887

(51) Int. Cl. B60H 1/26

(52) U.S. Cl. CPC B60H 1/26
USPC 454/151

(57) ABSTRACT

In an intake device for a fuel cell vehicle in which an intake duct supplies air to a fuel cell housed in a fuel cell case as a reaction gas, the intake duct includes a pair of top and bottom walls and a pair of left and right side walls, the top wall curves downward while extending from a front face of the fuel cell case toward the front side of vehicle, and an air introduction port opening toward a lower side of the vehicle is formed between a lower end portion of the top wall and a front end portion of the bottom wall.

### TECHNICAL FIELD

The present invention relates to an intake device for a fuel cell vehicle, and in particular, relates to an intake device for a fuel cell vehicle which is designed to stabilize an air introducing amount of a fuel cell and to prevent intrusion of water, snow, and the like.

### BACKGROUND ART

A fuel cell vehicle is equipped with a fuel cell including a fuel cell stack foamed by stacking a plurality of fuel-cell cells as a drive energy source. As an intake device for a fuel cell vehicle which efficiently takes in and supplies air to the fuel cell as a reaction gas reacting with hydrogen, there is an intake device in which a fuel cell case housing a fuel cell is disposed in a vehicle front portion with an air introduction surface of the fuel cell facing the front side of the vehicle, an intake duct is attached to a front face portion of the fuel cell case, and which supplies air taken into the intake duct to the fuel cell as the reaction gas.

There is a conventional intake device for a fuel cell vehicle in which an air introduction port of an intake duct taking in the outside air faces the front side of the vehicle and which supplies air introduced in from the intake duct to a fuel cell as a reaction gas, as shown in Japanese Patent Laid-Open No. 2009-37991.

### CITATION LIST

### Patent Literature

PTL 1: Japanese Patent Laid-Open No. 2009-37991

### SUMMARY OF INVENTION

### Technical Problems

However, the intake device described in PTL 1 has a problem in that, since the air introduction port is facing the front side of the vehicle, rain water, snow, and the like are likely to intrude into the intake duct while the vehicle is travelling. Moreover, the intake device described in PTL 1 has a problem in that, since travelling wind tends to enter the air introduction port facing the front side of the vehicle, an air introducing amount changes by the influence of the travelling speed. To counter this, the intake device described in PTL 1 is provided with a fan for introducing air and the air introducing amount is adjusted by controlling this fan. The structure of the intake device of PTL 1 is thus complex.

Furthermore, the intake device of PTL 1 has a structure in which the intake duct extends linearly toward the front side of the vehicle from the fuel cell and the air introduction port at an extended front end of the intake duct opens at a front end of the vehicle. Therefore, in the intake device described in PTL 1, the intake duct has such a shape that the intake duct is difficult to deform in a vehicle front-rear direction and that the intake duct is likely to receive force from the front side of the vehicle. Hence, the intake device has a problem in that an impact force in a frontal crash of the vehicle acts directly on the fuel cell via the intake duct.

An object of the present invention is to provide a structure of an intake device for a fuel cell vehicle which supplies air to a fuel cell as a reaction gas by using the intake duct, the structure facilitating adjustment of an air introducing amount and being capable of protecting the fuel cell in frontal crash of the vehicle.

### Solution to Problems

The present invention provides an intake device for a fuel cell vehicle in which: a fuel cell case housing a fuel cell is disposed in a front portion of the vehicle; an air introduction surface of the fuel cell faces a front side of the vehicle while an intake duct is attached to a front face portion of the fuel cell case; and air taken into the intake duct is supplied to the fuel cell as a reaction gas, wherein the intake duct includes a pair of top and bottom walls and a pair of left and right side walls, the top wall curves downward while extending away from the front face of the fuel cell case toward the front side of the vehicle, and an air introduction port opening toward a lower side of the vehicle is formed between a lower end portion of the top wall and a front end portion of the bottom wall.

### Advantageous Effects of Invention

Since the intake device for the fuel cell vehicle of the present invention has such a structure that the air introduction port of the intake duct opens toward the lower side of the vehicle, an amount of air taken into the intake duct does not change depending on the travelling speed of the vehicle and adjustment of an air introducing amount can be facilitated. Moreover, the intake device for a fuel cell vehicle of the present invention can prevent intrusion of water and snow running toward the intake duct from the front of the vehicle into the intake duct.

Furthermore, in the intake device for the fuel cell vehicle of the present invention, since the air introduction port has a shape easily deformable in the vehicle front-rear direction and is disposed in a front end portion of the intake duct, the intake duct is easily crushed by an impact from the front side of the vehicle. Accordingly, it is possible to improve an impact absorption performance in a frontal crash and protect the fuel cell.

### BRIEF DESCRIPTION OF DRAWINGS

FIG. 1 is a right-side view of a front portion of a fuel cell vehicle. (Embodiment)

FIG. 2 is a right-side view of an intake device for the fuel cell vehicle. (Embodiment)

FIG. 3 is a perspective view of the intake device for the fuel cell vehicle, the intake device viewed from a right front upper side. (Embodiment)

FIG. 4 is a perspective view of the intake device for the fuel cell vehicle, the intake device viewed from a right front lower side. (Embodiment)

### DESCRIPTION OF EMBODIMENT

An embodiment of the present invention is described below based on the drawings.

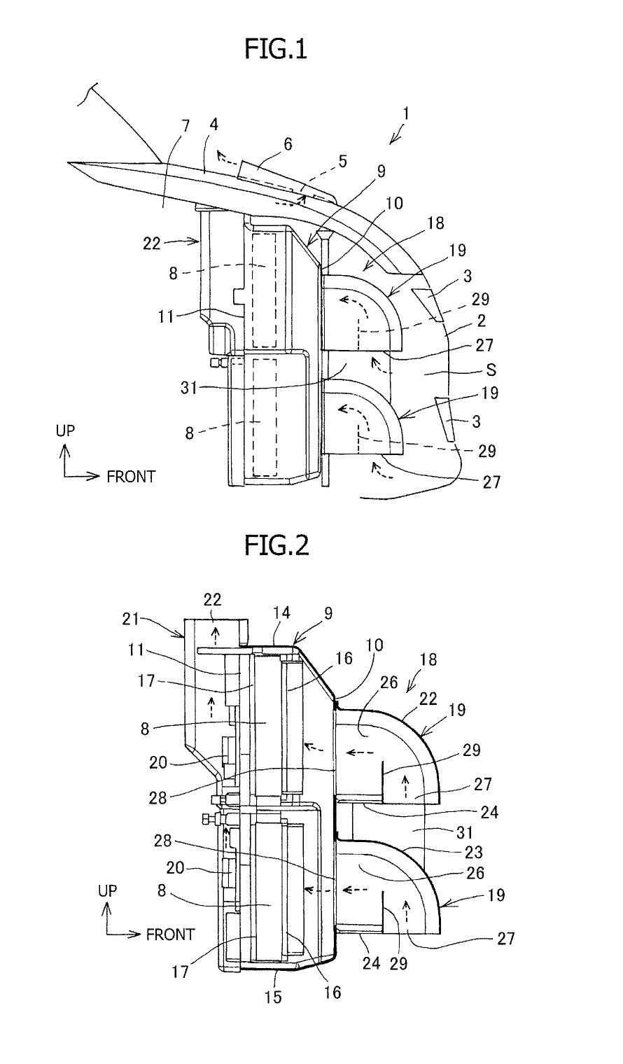

FIGS. 1 to 4 illustrate the embodiment of the present invention. In FIG. 1, reference numeral 1 denotes a fuel cell vehicle, reference numeral 2 denotes a front bumper, reference numeral 3 denotes an opening portion of a front grille, reference numeral 4 denotes a front hood, reference numeral 5 denotes an exhaust opening portion in the front hood 4, reference numeral 6 denotes a cover of the exhaust opening portion 5, and reference numeral 7 denotes a front compartment. In the fuel cell vehicle 1, a fuel cell case 9 housing fuel cells 8 is disposed in the front compartment 7 in a vehicle front portion.

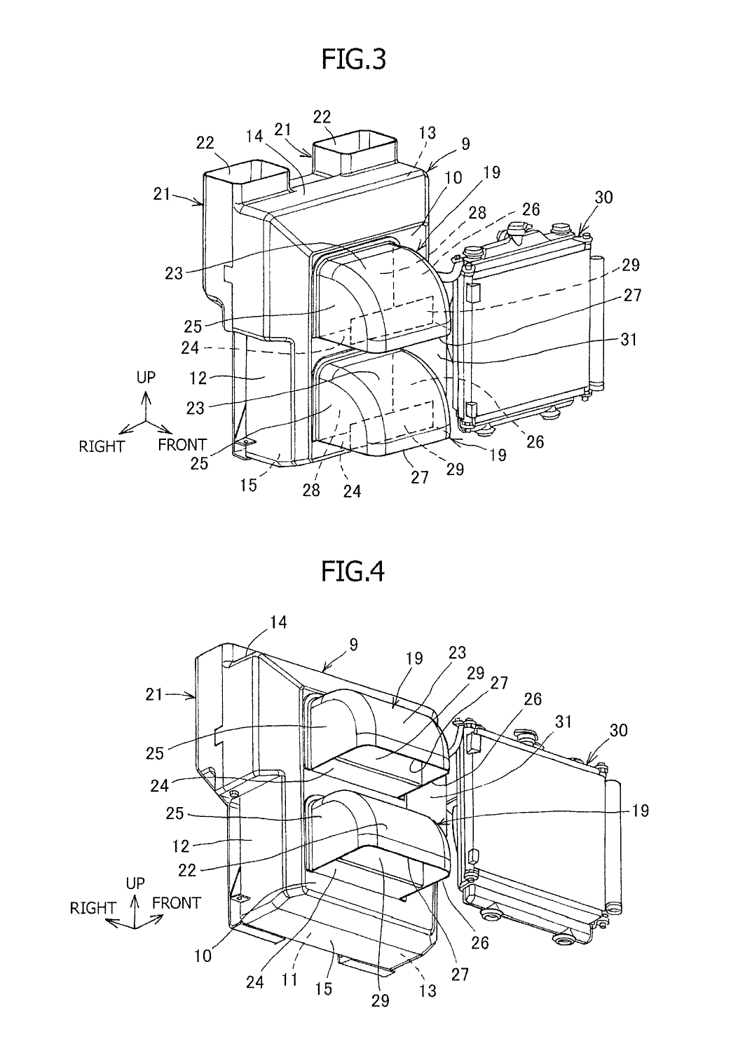

As shown in FIGS. 3 and 4, the fuel cell case 9 is formed of a front face portion 10, a rear face portion 11, left and right side face portions 12 and 13, an upper face portion 14, and a lower face portion 15 to have a substantially-rectangular box shape which is thin in a front-rear direction and which is longer in an vertical direction than in a left-right direction. In the fuel cells 8, a plurality of fuel-cell cells are stacked and fuel cell stacks are thereby formed. As shown in FIG. 2, each of the fuel cells 8 are installed in the fuel cell case 9 in such a way that an air introduction surface 16 faces toward the front side of the vehicle while an air discharging surface 17 faces toward the rear side of the vehicle.

As shown in FIGS. 1 and 2, in an intake device 18 of the fuel cell vehicle 1, intake ducts 19 are attached to the front face portion 10 of the fuel cell case 9. The intake device 18 supplies air taken into the intake ducts 19 to the air introduction surface 16 side of the fuel cells 8 as a reaction gas. Moreover, in the fuel cell case 9, exhaust fans 20 are attached to the rear face portion 11 to face the air discharging surfaces 17 of the fuel cells 8 and exhaust ducts 21 which cover the exhaust fans 20 and which extend in the vertical direction are attached to the fuel cell case 9.

Each of the exhaust ducts 21 has an exhaust port 22 opening to the exhaust opening portion 5 of the front hood 4 at an upper end. Exhaust from the fuel cells 8 is guided by the exhaust duct 21 to the outside of the front compartment 7 through the exhaust opening portion 5 of the front hood 4 and is discharged toward the rear side of the vehicle by the cover 6 of the front hood 4.

As shown in FIG. 2, in the intake device 18 of the fuel cell vehicle 1, a plurality (two in the embodiment) of the fuel cells 8 are installed inside the fuel cell case 9 while being arranged one on top of another in the vehicle vertical direction and a plurality (two in the embodiment) of the intake ducts 19 are attached to the front face portion 10 of the fuel cell case 9 while being arranged one on top of another in the vehicle vertical direction. As shown in FIGS. 3 and 4, each of the intake ducts 19 includes a pair of top and bottom walls 23, 24 and a pair of left and right side walls 25, 26. In each intake duct 19, the top wall 23 curves downward while extending away from the front face portion 10 of the fuel cell case 9 toward the front side of the vehicle and an air introduction port 27 opening toward the vehicle lower side is formed between a lower end portion of the top wall 23 and a front end portion of the bottom wall 24. The intake device 18 supplies the air, which has been introduced in from the air introduction ports 27 of the intake ducts 19, to the air introduction surface 16 side of the fuel cells 8 from front face opening portions 28 of the front face portion 10 of the fuel cell case 9.

Since the intake device 18 of the fuel cell vehicle 1 has such a structure that the air introduction ports 27 of the intake ducts 19 open toward the lower side of the vehicle, an amount of air taken into the intake ducts 19 does not change depending on the travelling speed of the vehicle and adjustment of an air introducing amount can be facilitated.

Moreover, in the intake device 18 of the fuel cell vehicle 1, since water and snow running toward the intake ducts 19 from the front of the vehicle are less likely to enter the air introduction ports 27 opening toward the lower side of the vehicle, intrusion of water and snow into the intake ducts 19 can be prevented.

Furthermore, in the intake device 18 of the fuel cell vehicle 1, since the air introduction ports 27 have a shape easily deformable in the vehicle front-rear direction and are disposed in front end portions of the intake ducts 19, the intake ducts 19 are easily crushed by an impact from the front side of the vehicle. Therefore, the intake device 18 can improve an impact absorption performance in a frontal crash and protect the fuel cells 8.

As shown in FIGS. 1 and 2, in the intake device 18 of the fuel cell vehicle 1, the two intake ducts 19 are arranged one on top of another in the vehicle vertical direction in the front face portion 10 of the fuel cell case 9.

The intake device 18 can thereby evenly supply air to the air introduction surfaces 16 of the two fuel cells 8 arranged one on top of another in the vehicle vertical direction. Moreover, in the intake device 18, air flowing toward the intake ducts 19 from the front side of the vehicle can rise along the top wall 23 of the intake duct 19 disposed on the lower side in the vehicle vertical direction and be guided toward the air introduction port 27 of the intake duct 19 on the upper side which is disposed above the intake duct 19 on the lower side. Therefore, in the intake device 18, the amounts of air flowing respectively into the two intake ducts 19 on the upper and lower sides can be made even.

Moreover, in the intake device 18 of the fuel cell vehicle 1, since there are two divided intake ducts 19, the length of each intake duct 19 in the vehicle front-rear direction can be reduced and an impact absorption space S in front of the intake ducts 19 can be increased. Therefore, the intake device 18 can improve the impact absorption performance in frontal crash and protect the fuel cells 8.

As shown in FIGS. 1 and 2, in the intake device 18 of the fuel cell vehicle 1, a partition plate 29 extending toward the vehicle upper side is connected to the front end portion of the bottom wall 24. The partition plate 29 is connected to the pair of left and right side walls 25, 26 at both ends in the vehicle width direction and an upper end thereof is disposed below and away from the top wall 23.

Accordingly, in the intake device 18, water intruding into the air introduction port 27 from the oblique front lower side hits the partition plate 29 and drops. The water can be thereby prevented from intruding into the fuel cell case 9.

As shown in FIGS. 3 and 4, in the intake device 18 of the fuel cell vehicle 1, the two intake ducts 19 are arranged one on top of another in a space lateral to a radiator 30 in the vehicle width direction and the upper and lower side walls 26 of the two intake ducts 19 which are located on the radiator 30 side in the vehicle width direction are connected to each other by a dividing wall 31.

Therefore, in the intake device 18, the dividing wall 31 can prevent hot air having passed through the radiator 30 from flowing toward the air introduction ports 27 and prevent the hot air from intruding into the intake ducts 19 from the air introduction ports 27.

### INDUSTRIAL APPLICABILITY

The present invention provides a structure capable of facilitating adjustment of the air introducing amount into a fuel cell of a fuel cell vehicle and protecting the fuel cell in frontal crash of the vehicle, and can be applied not only to the fuel cell vehicle but also to a device including a cooling intake duct which takes in air from a front face of a vehicle in which an internal combustion engine is mounted.

### REFERENCE SIGNS LIST

1 Fuel cell vehicle
7 Front compartment
8 Fuel cell
9 Fuel cell case
10 Front face portion
16 Air introduction surface
18 Intake device
19 Intake duct
20 Exhaust fan
21 Exhaust duct
23 Top wall
24 Bottom wall
25, 26 Side wall
27 Air introduction port
28 Front face opening portion
29 Partition plate
30 Radiator
31 Dividing wall

1. An intake device for a fuel cell vehicle having: a fuel cell disposed in a vehicle front portion with an air introduction surface facing toward a front side of the vehicle; and a fuel cell case housing the fuel cell, the intake device comprising:
an intake duct attached to a front face portion of the fuel cell case such that air taken into the intake duct is supplied to the fuel cell as a reaction gas,
wherein the intake duct comprises a pair of top and bottom walls and a pair of left and right side walls; the top wall curves downward while extending from a front face of the fuel cell case toward the front side of the vehicle; and an air introduction port opening toward a lower side of the vehicle is formed between a lower end portion of the top wall and a front end portion of the bottom wall.

2. The intake device for the fuel cell vehicle according to claim 1, wherein a plurality of the intake ducts are arranged one on top of another in a vehicle vertical direction in the front face portion of the fuel cell case.

3. The intake device for the fuel cell vehicle according to claim 1, wherein a partition plate extending toward an upper side of the vehicle is connected to the front end portion of the bottom wall.

4. The intake device for the fuel cell vehicle according to claim 2, wherein the fuel cell vehicle further comprises a radiator; the plurality of intake ducts are arranged one on top of another in a space lateral to the radiator in a vehicle width direction; and the side walls of the plurality of intake ducts which are located on the radiator side are connected to each other by a dividing wall.
